(19) United States
(12) Patent Application Publication
(10) Pub. No.: US 2008/0018069 A1
(43) Pub. Date: Jan. 24, 2008

(54) Traveling server

(76) Inventor: Michele Visotzky, Medford, NY (US)

Correspondence Address: Michele Visotzky, 281 Southaven Ave., Medford, NY, 11763, US

(21) Appl. No.: 11/448,905

(22) Filed: Jul. 24, 2006

(51) Int. Cl. B62B 3/00

(52) U.S. Cl. 280/47.34

(57) ABSTRACT

Instead of lifting hot, heavy serving dishes at the dinner table, it would be much more convenient to push the serving dishes from one person to another. Dinner would be more enjoyable and the chore of straining yourself to lift something hot and heavy would be eliminated. Dinner parties are meant to be fun and relaxing, not exerting.

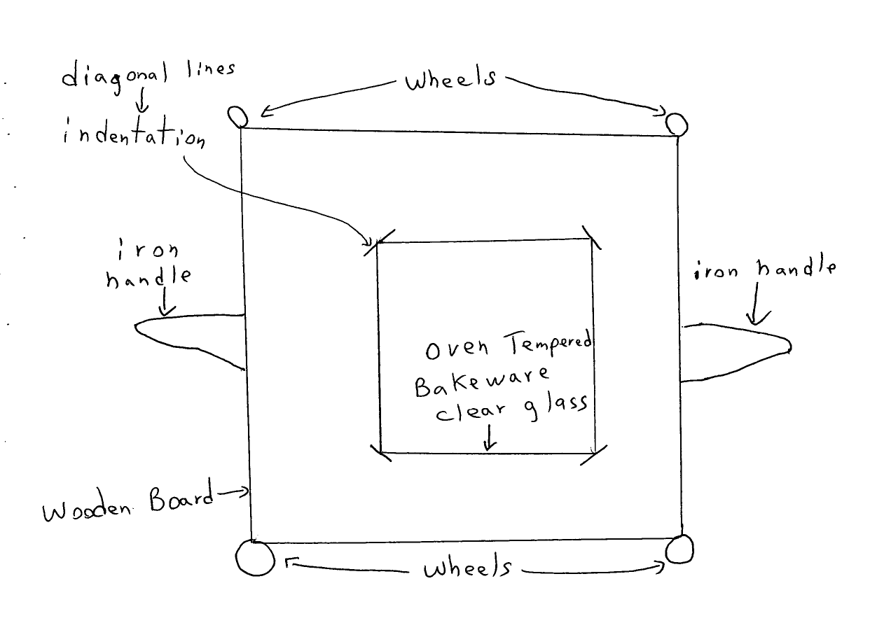

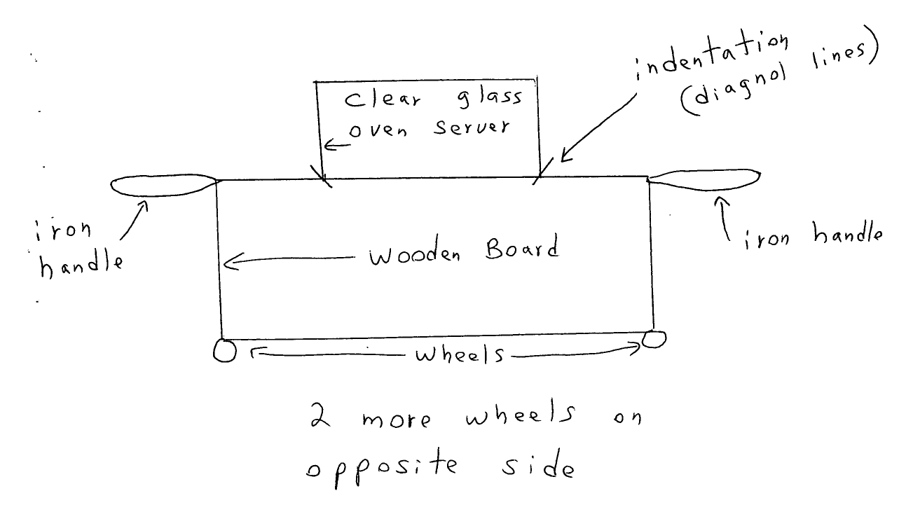

The wheels at the bottom of the board which supports the serving dish, make the serving dish easy to move and the handles would increase the convenience of mobility.

Consists of a wooden board; 12″ square & 2″ deep, supporting a hot, clear glass, oven tempered pan which is 10″ square & 2″ deep. Four wheels are at the bottom of the wooden board in each corner. The wheels move slowly because the server is on top of the dinner table.

The wheels enable the hot serving pan to be passed from one person to another at the dinner table without anyone lifting or touching the hot, heavy pan. There is a 2″ indentation in the wooden board for the serving pan. On either end of the wooden board are two iron, oval shaped handles, 4″ each. These handles are what the people use to wheel the Traveling Server from one person to another.

1. A Traveling Serving Dish will enable passing a heavy, hot serving dish around the dinner table easier (Wheels on the bottom)
